(19) United States
(12) Patent Application Publication
(10) Pub. No.: US 2024/0405266 A1
(43) Pub. Date: Dec. 5, 2024

(54) ION-CONDUCTIVE SOLID AND ALL-SOLID-STATE BATTERY

(71) Applicant: CANON OPTRON, INC., Ibaraki (JP)

(72) Inventors: Saori FUJIKURA, Tochigi (JP); Noriko SAKAMOTO, Tochigi (JP); Takeshi KOBAYASHI, Ibaraki (JP); Yoshitaka SHIBA, Tochigi (JP)

(21) Appl. No.: 18/799,770

(22) Filed: Aug. 9, 2024

Related U.S. Application Data
(63) Continuation of application No. PCT/JP2023/004691, filed on Feb. 13, 2023.

(30) Foreign Application Priority Data
Mar. 14, 2022 (JP) 2022-039235

(51) Int. Cl. H01M 10/0562; H01M 10/0525

(52) U.S. Cl. CPC H01M 10/0562; H01M 10/0525; H01M 2300/0074

(57) ABSTRACT

An ion conductive solid that can be produced by heat treatment at low temperature and has a high ion conductivity; and the ion conductive solid comprises an oxide represented by a general formula: Li_{6+a-c-2d}Yb_{1-a-b-c-d}M1ₐM2_{b}M3_{c}M4_{d}B₃O₉ (In the formula, M1 is at least one metal element selected from the group consisting of Mg, Mn, Zn, Ni, Ca, Sr, and Ba, M2 is at least one metal element selected from the group consisting of La, Pr, Nd, Sm, Eu, Gd, Tb, Dy, Ho, Er, Tm, Lu, In, and Fe, M3 is at least one metal element selected from the group consisting of Zr, Ce, Hf, Sn, and Ti, M4 is at least one metal element selected from the group consisting of Nb and Ta, and a, b, c, and d are real numbers of which each is in a specific range).

### CROSS REFERENCE TO RELATED APPLICATIONS

This application is a Continuation of PCT International Application No. PCT/JP2023/004691, filed on Feb. 13, 2023, which is claiming priority of Japanese Patent Application No. 2022-039235, filed on Mar. 14, 2022, all of which are hereby expressly incorporated by reference into the present application.

### BACKGROUND OF THE INVENTION

### Field of the Invention

The present disclosure relates to an ion conductive solid and an all-solid-state battery.

### Description of the Related Art

Conventionally, light-weight and high-capacity lithium ion secondary batteries have been included in mobile devices such as smartphones and notebook computers, and transport devices such as electric vehicles and hybrid electric vehicles.

However, since liquids containing combustible solvents have been used as electrolytes in conventional lithium ion secondary batteries, the leakage of the combustible solvents and ignition in the case of the short circuit of the batteries have been feared. Thus, in recent years, secondary batteries using ion conductive solids as electrolytes, which is different from the liquid electrolytes, to secure safety, have received attention, and such secondary batteries are referred to as all-solid-state batteries.

As the electrolytes used in the all-solid-state batteries, solid electrolytes such as oxide-based solid electrolytes and sulfide-based solid electrolytes have been widely known. Among them, the oxide-based solid electrolytes do not react with moisture in the atmosphere, and do not generate hydrogen sulfide, thus, the oxide-based solid electrolytes are safer than the sulfide-based solid electrolytes.

Incidentally, an all-solid-state battery comprises: a cathode comprising a cathode active material; an anode comprising an anode active material; an electrolyte, which is comprising an ion conductive solid, that is placed between the cathode and the anode; and, if necessary, a current collector (the cathode active material and the anode active material are collectively referred to as “electrode active material”). In a case in which the all-solid-state battery is manufactured using an oxide-based solid electrolyte, heat treatment is performed to reduce the contact resistance between the particles of an oxide-based material comprised in the solid electrolyte. However, in a conventional oxide-based solid electrolyte, a high temperature of 900° C. or more is required in the heat treatment, and the solid electrolyte and the electrode active material may therefore react to form a high-resistance phase. The high-resistance phase may lead to a decrease in the ionic conductivity of the ion conductive solid, and in turn to a decrease in the output of the all-solid-state battery.

Examples of oxide-based solid electrolytes that can be produced by heat treatment at a temperature of less than 900° C. include Li₂₊ₓC₁₋ₓBₓO₃ (Solid State Ionic 288 (2016) 248-252).

Moreover, it is disclosed that characteristics can be improved by allowing the Li₂₊ₓC₁₋ₓBₓO₃ described above to contain a specific element at a specific ratio (Japanese Patent No. 6948676).

### SUMMARY OF THE INVENTION

The present disclosure provides: an ion conductive solid that can be produced by heat treatment at low temperature and has a high ion conductivity; and an all-solid-state battery comprising the ion conductive solid.

An ion conductive solid of the present disclosure is an ion conductive solid comprising an oxide represented by a general formula: Li_{6+a-c-2d} Yb_{1-a-b-c-a}M1ₐM2_{b}M3_{c}M4_{d}B₃O₉
(in the formula, M1 is at least one metal element selected from a group consisting of Mg, Mn, Zn, Ni, Ca, Sr, and Ba,
M2 is at least one metal element selected from a group consisting of La, Pr, Nd, Sm, Eu, Gd, Tb, Dy, Ho, Er, Tm, Lu, In, and Fe,
M3 is at least one metal element selected from a group consisting of Zr, Ce, Hf, Sn, and Ti,
M4 is at least one metal element selected from a group consisting of Nb and Ta, and
a is 0.000≤a≤0.800, b is 0.000≤b≤0.900, c is 0.000≤c≤0.800, d is 0.000≤d≤0.800, and a, b, c, and d are real numbers satisfying 0.000≤a+b+c+d<1.000).

An all-solid-state battery of the present disclosure is an all-solid-state battery comprising at least:
a cathode;
an anode; and
an electrolyte,
wherein at least one selected from a group consisting of the cathode, the anode, and the electrolyte comprises the ion conductive solid of the present disclosure.

In accordance with one aspect of the present disclosure, there can be obtained: an ion conductive solid that can be produced by heat treatment at low temperature and has a high ion conductivity; and an all-solid-state battery comprising the ion conductive solid. Further features of the present disclosure will become apparent from the following description of exemplary embodiments.

### DESCRIPTION OF THE EMBODIMENTS

In the present disclosure, a description of “XX or more and YY or less” or “XX to YY” representing a numerical range means a numerical range including lower and upper limits which are end points, unless otherwise specified. When numerical ranges are described in a stepwise manner, the upper and lower limits of each numerical range may be optionally combined.

Further, in the present disclosure, “solid” refers to the state of matter having a certain shape and volume, in the three states of matter, and a powdery state is included in “solid”.

An ion conductive solid of the present disclosure is an ion conductive solid comprising an oxide represented by a general formula: Li_{6+a-c-2d} Yb_{1-a-b-c-d}M1ₐM2_{b}M3_{c}M4_{d}B₃O₉.

In the formula, M1 is at least one metal element selected from a group consisting of Mg, Mn, Zn, Ni, Ca, Sr, and Ba,
M2 is at least one metal element selected from a group consisting of La, Pr, Nd, Sm, Eu, Gd, Tb, Dy, Ho, Er, Tm, Lu, In, and Fe,
M3 is at least one metal element selected from a group consisting of Zr, Ce, Hf, Sn, and Ti,
M4 is at least one metal element selected from a group consisting of Nb and Ta, and
a is 0.000≤a≤0.800, bis 0.000≤b≤0.900, c is 0.000≤c≤0.800, d is 0.000≤d≤0.800, and a, b, c, and d are real numbers satisfying 0.000≤a+b+c+d<1.000.

As the reason that an ionic conductivity is improved in the ion conductive solid comprising the oxide represented by the general formula as described above, the present inventors presume as follows.

Substitution of Y in Li₆YB₃O₉ described in Comparative Example 1 in Japanese Patent No. 6948676 with Yb having a small ionic radius result in decreases in a lattice constant and a lattice volume, facilitates movement of Lit, and therefore causes improvement in ionic conductivity.

In addition, in Japanese Patent No. 6948676, substitution of some of Y which are trivalent metal elements with tetravalent to pentavalent metal elements causes the balance of charge to be adjusted by the substitution between the elements having different valences, and results in improvement in ion conductivity. Use of Yb instead of such Y results in decreases in a lattice constant and a lattice volume, further facilitates movement of Li⁺, and therefore causes further improvement in ionic conductivity.

The ion conductive solid of the present disclosure preferably has a monoclinic crystal structure.

The ion conductive solid of the present disclosure preferably has a volume mean particle diameter of 0.1 μm or more and 28.0 μm or less, more preferably 0.2 μm or more and 26.0 μm or less, still more preferably 0.3 μm or more and 20.0 μm or less, even more preferably 0.3 μm or more and 15.0 μm or less, and more preferably 0.5 μm or more and 10.0 μm or less. The above-described range results in a reduction in grain-boundary resistivity in an ion conductive solid, and in more improvement in ionic conductivity.

The volume mean particle diameter of the ion conductive solid can be controlled by pulverization or classification.

In the general formula as described above, a is a real number satisfying 0.000≤a≤0.800.

The a is 0.000≤a≤0.800, preferably 0.000≤a≤0.600, more preferably 0.000≤a≤0.400, still more preferably 0.000≤a≤0.100, particularly preferably 0.000≤a≤0.050, and most preferably 0.000≤a≤0.030.

In the general formula as described above, b is a real number satisfying 0.000≤b≤0.900.

The b is 0.000≤b≤0.900, preferably 0.000≤b≤0.600, more preferably 0.000≤b≤0.500, still more preferably 0.000≤b≤0.400, even more preferably 0.000≤b≤0.100, particularly preferably 0.000≤b≤0.050, and most preferably 0.000≤b≤0.030.

In the general formula as described above, c is a real number satisfying 0.000≤c≤0.800.

The c is 0.000≤c≤0.800, preferably 0.000≤c≤0.600, more preferably 0.000≤c≤0.400, still more preferably 0.000≤c≤0.150, even more preferably 0.000≤c≤0.100, particularly preferably 0.000≤c≤0.050, and most preferably 0.000≤c≤0.030. Moreover, c may be preferably 0.050≤c≤0.200, and more preferably 0.080≤c≤0.150.

In the general formula as described above, d is a real number satisfying 0.000≤d≤0.800.

The d is 0.000≤d≤0.800, preferably 0.000≤d≤0.600, more preferably 0.000≤d≤0.400, still more preferably 0.000≤d≤0.100, particularly preferably 0.000≤d≤0.050, and most preferably 0.010≤d≤0.030.

In the general formula as described above, a+b+c+d is a real number satisfying 0.000≤a+b+c+d<1.000.

The a+b+c+d is 0.000≤a+b+c+d<1.000, preferably 0.000≤a+b+c+d<0.900, more preferably 0.000≤a+b+c+d<0.800, still more preferably 0.000≤a+b+c+d<0.700, even more preferably 0.000≤a+b+c+d≤0.600, especially preferably 0.010≤a+b+c+d<0.500, particularly preferably 0.050≤a+b+c+d<0.300, and most preferably 0.080≤a+b+c+d<0.250.

In Yb_{1-a-b-c-d}, 1-a-b-c-d is preferably 0.300≤1-a-b-c-d, more preferably 0.500≤1-a-b-c-d, still more preferably 0.700≤1-a-b-c-d, and even more preferably 0.750≤1-a-b-c-d. The upper limit thereof is not particularly limited, but is preferably less than 1.000, 0.950 or less, and 0.900 or less.

The ion conductive solid of the present disclosure may be allowed to be, for example, the following embodiments, but is not limited to the embodiments.
(1) It suffices that a satisfies 0.010≤a≤0.100, b satisfies 0.000≤b≤0.200, c satisfies 0.000≤c≤0.200, d satisfies 0.010≤d≤0.100, and a, b, c, and d satisfy 0.010≤a+b+c+d<0.300.
(2) It suffices that a satisfies 0.010≤a≤0.030, b satisfies 0.030≤b≤0.100, c satisfies 0.010≤c≤0.030, d satisfies 0.010≤d≤0.030, and a, b, c, and d satisfy 0.050≤a+b+c+d<0.160.
(3) It suffices that a satisfies 0.000≤a≤0.010, b satisfies 0.000≤b≤0.100, c satisfies 0.050≤c≤0.150, d satisfies 0.000≤d≤0.030, and a, b, c, and d satisfy 0.050≤a+b+c+d<0.250.

M1, M2, M3, and M4 in the general formula above may or may not be included in the formula. In other words, at least one of a, b, c, and d may be zero. It means that one of a, b, c and d may be zero, more than one may be zero, or all may be zero.

In the general formula as described above, M1 is at least one metal element selected from the group consisting of Mg, Mn, Zn, Ni, Ca, Sr, and Ba.

M1 is at least one selected from the group consisting of Mg, Mn, Zn, Ni, Ca, Sr, and Ba, preferably at least one selected from the group consisting of Mg, Zn, Ca, Sr, and Ba, and more preferably at least one selected from the group consisting of Mg, Ca, and Sr.

In the general formula as described above, M2 is at least one metal element selected from the group consisting of La, Pr, Nd, Sm, Eu, Gd, Tb, Dy, Ho, Er, Tm, Lu, In, and Fe.

M2 is at least one selected from the group consisting of La, Pr, Nd, Sm, Eu, Gd, Tb, Dy, Ho, Er, Tm, Lu, In, and Fe, preferably at least one selected from the group consisting of La, Eu, Gd, Tb, Dy, Lu, In, and Fe, and more preferably at least one selected from the group consisting of Gd, Dy, Lu, In, and Fe.

In the general formula as described above, M3 is at least one metal element selected from the group consisting of Zr, Ce, Hf, Sn, and Ti.

M3 is at least one selected from the group consisting of Zr, Ce, Hf, Sn, and Ti, preferably at least one selected from the group consisting of Zr, Ce, Hf, and Sn, and more preferably at least one selected from the group consisting of Zr, Ce, and Hf.

In the general formula as described above, M4 is at least one metal element selected from the group consisting of Nb and Ta.

M4 is at least one selected from the group consisting of Nb and Ta, and preferably Nb.

Moreover, when a portion of Yb which are trivalent metal elements is substituted within a specific ratio range using specific elements M1, M2, M3, and M4, the balance of charge to be adjusted by the substitution between the elements having different valences. Therefore, a state in which Lit in the crystal lattice is deficient occurs. Since the surrounding Lit moves in to fill that Lit deficiency, the ionic conductivity is improved.

A method of producing the ion conductive solid of the present disclosure will now be described.

The method of producing the ion conductive solid of the present disclosure can be allowed to be the following aspect, but is not limited thereto.

A method of producing an ion conductive solid comprising an oxide represented by a general formula: Li_{6+a-c-2d} Y_{b1-a-b-c-d}M1ₐM2_{b}M3_{c}M4_{d}B₃O₉, the method being able to include:
a primary baking step of heat-treating raw materials, mixed to obtain the oxide represented by the general formula, at a temperature that is less than the melting point of the oxide.

In the formula, M1 is at least one metal element selected from the group consisting of Mg, Mn, Zn, Ni, Ca, Sr, and Ba, M2 is at least one metal element selected from the group consisting of La, Pr, Nd, Sm, Eu, Gd, Tb, Dy, Ho, Er, Tm, Lu, In, and Fe, M3 is at least one metal element selected from the group consisting of Zr, Ce, Hf, Sn, and Ti, M4 is at least one metal element selected from the group consisting of Nb and Ta, a is 0.000≤a≤0.800, bis 0.000≤b≤0.900, c is 0.000≤c≤0.800, d is 0.000≤d≤0.800, and a, b, c, and d are real numbers satisfying 0.000≤a+b+c+d<1.000.

The method of producing the ion conductive solid of the present disclosure can include the primary baking step of weighing and mixing the raw materials to obtain the oxide represented by the general formula as described above, heat-treating the raw materials at a temperature that is less than the melting point of the oxide, and thereby producing the ion conductive solid comprising the oxide. The ion conductive solid can be obtained by the primary baking step.

The production method may further include, as needed, a secondary baking step of heat-treating the ion conductive solid comprising the obtained oxide at a temperature that is less than the melting point of the oxide, and producing a sintered body of the ion conductive solid comprising the oxide.

The method of producing the ion conductive solid of the present disclosure, including the above-described primary baking step and the above-described secondary baking step, will be described in detail below, however, the present disclosure is not limited to the following production method.

### Primary Baking Step

In the primary baking step, raw materials, such as Li₃BO₃, H₃BO₃, Yb₂O₃, ZrO₂, CeO₂, or HfO₂, of the chemical reagent grade are weighed in stoichiometric amounts, and mixed to achieve the general formula: Li_{6+a-c-2d} Yb_{1-a-b-c-d}M1ₐM2_{b}M3_{c}M4_{d}B₃O₉ (wherein M1 is any one or more metal elements selected from Mg, Mn, Zn, Ni, Ca, Sr, and Ba, M2 is any one or more metal elements selected from La, Pr, Nd, Sm, Eu, Gd, Tb, Dy, Ho, Er, Tm, Lu, In, and Fe, M3 is any one or more metal elements selected from Zr, Ce, Hf, Sn, and Ti, M4 is any one or more metal elements selected from Nb and Ta, a is 0.000≤a≤0.800, b is 0.000≤b≤0.900, c is 0.000≤c≤0.800, d is 0.000≤d≤0.800, and a, b, c, and d are real numbers satisfying 0.000≤a+b+c+d<1.000).

An apparatus used in the mixture is not particularly limited. For example, a pulverizing-type mixer such as a planetary ball mill can be used as the apparatus. The material and capacity of a container used in the mixture, and the material and diameter of the ball are not particularly limited, and can be selected as appropriate depending on the kinds and amounts of the raw materials used. As an example, a 45 mL container made of zirconia, and a ball that has a diameter of 5 mm and is made of zirconia can be used. Moreover, the conditions of mixture treatment are not particularly limited but can be set at, for example, a rotation number of 50 rpm to 2000 rpm, and a time of 10 minutes to 60 minutes.

After the powder mixture of each of the raw materials described above is obtained by the mixture treatment, then the obtained powder mixture is pressure-molded to make pellets. As a pressure molding method, a known pressure molding method such as a cold uniaxial molding method or a cold isostatic pressure molding method can be used. The condition of the pressure molding in the primary baking step is not particularly limited but can be set at, for example, a pressure of 100 MPa to 200 MPa.

The obtained pellets are baked using a baking apparatus such as an atmosphere baking apparatus. A temperature at primary baking and solid-phase synthesis are performed is not particularly limited as long as the temperature is less than the melting point of the ion conductive solid represented by the general formula: Li_{6+a-c-2d} Y_{b1-a-b-c-d}M1ₐM2_{b}M3_{c}M4_{d}B₃O₉. A temperature at which primary baking is performed can be set at, for example, less than 700° C., 680° C. or less, 670° C. or less, 660° C. or less, or 650° C. or less, and can be set at, for example, 500° C. or more. The numerical ranges can be optionally combined. The temperature in such a range as described above sufficiently enables the solid-phase synthesis. The time of the primary baking step is not particularly limited but can be set at, for example, around 700 minutes to 750 minutes.

The primary baking step described above enables production of the ion conductive solid comprising the oxide represented by the general formula as described above: Li_{6+a-c-2d} Y_{b1-a-b-c-d}M1ₐM2_{b}M3_{c}M4_{d}B₃O₉. The powder of the ion conductive solid comprising the oxide can also be obtained by pulverizing the ion conductive solid comprising the oxide using a mortar/pestle or a planetary mill.

### Secondary Baking Step

In the secondary baking step, at least one selected from the group consisting of the ion conductive solid comprising the oxide obtained in the primary baking step, and the powder of the ion conductive solid comprising the oxide is pressured molded as necessary and sintered to obtain the sintered body of the ion conductive solid comprising the oxide. It is acceptable to simultaneously perform the pressure molding and the secondary baking using discharge plasma sintering (hereinafter also simply referred to as “SPS”), hot press, or the like, or it is acceptable to produce pellets by cold uniaxial molding and to then perform the secondary baking in an ambient atmosphere, oxidizing atmosphere, reducing atmosphere, or the like. The conditions described above enable an ion conductive solid having a high ionic conductivity to be obtained without causing melting due to heat treatment. The condition of the pressure molding in the secondary baking step is not particularly limited but can be set at, for example, a pressure of 10 MPa to 100 MPa.

The temperature at which the secondary baking is performed is less than the melting point of the ion conductive solid represented by the general formula: Li_{6+a-c-2d}Yb_{1-a-b-c-d}M1ₐM2_{b}M3_{c}M4_{d}B₃O₉. The temperature at which the secondary baking is performed is preferably less than 700° C., more preferably 680° C. or less, still more preferably 670° C. or less, and particularly preferably 660° C. or less. The lower limit of the temperature is not particularly limited, but it is preferable to reduce the lower limit as much as possible, for example, the lower limit is 500° C. or more. The numerical ranges can be optionally combined, and can be set in a range of, for example, 500° C. or more and less than 700° C. The range described above enables the ion conductive solid comprising the oxide of the present disclosure to be inhibited from being melted or decomposed in the secondary baking step, and enables the sintered body of the ion conductive solid comprising the oxide of the present disclosure, which has been sufficiently sintered, to be obtained.

The time for which the secondary baking step is performed can be changed as appropriate depending on the temperature or pressure at which the secondary baking is performed, and the like, is preferably 24 hours or less, and may be set at 14 hours or less. The time for which the secondary baking step is performed may be set at, for example, 5 minutes or more, 1 hour or more, and 6 hours or more.

A method of cooling the sintered body of the ion conductive solid comprising the oxide of the present disclosure, obtained in the secondary baking step, is not particularly limited, but may be subjected to natural radiational cooling (radiational cooling in a furnace), to rapid cooling, or to slower cooling than natural radiational cooling, or may be maintained at a certain temperature during cooling. An all-solid-state battery of the present disclosure will now be described.

An all-solid-state battery commonly comprises: a cathode; an anode; an electrolyte that is placed between the cathode and the anode, and comprises an ion conductive solid; and, if necessary, a current collector.

The all-solid-state battery of the present disclosure comprises at least: a cathode;
an anode; and
an electrolyte,
wherein at least one selected from the group consisting of the cathode, the anode, and the electrolyte comprises the ion conductive solid of the present disclosure.

The all-solid-state battery of the present disclosure may be a bulk-type battery, or may be a thin-film battery. The specific shape of the all-solid-state battery of the present disclosure is not particularly limited, but examples include the shape of coin, the shape of button, the shape of sheet, and layered shapes.

The all-solid-state battery of the present disclosure comprises the electrolyte. Moreover, in the all-solid-state battery of the present disclosure, at least the electrolyte preferably comprises the ion conductive solid of the present disclosure.

The solid electrolyte in the all-solid-state battery of the present disclosure may comprise the ion conductive solid of the present disclosure, may comprise another ion conductive solid, or may comprise an ionic liquid or a gel polymer. The other ion conductive solid is not particularly limited but may comprise an ion conductive solid that is usually used in an all-solid-state battery, for example, LiI, Li₃PO₄, Li₂La₃Zr₂O₁₂, or the like. The content of the ion conductive solid of the present disclosure in the electrolyte in the all-solid-state battery of the present disclosure is not particularly limited, but is preferably 25% by mass or more, more preferably 50% by mass or more, still more preferably 75% by mass or more, and particularly preferably 100% by mass.

The all-solid-state battery of the present disclosure comprises the cathode. The cathode may comprise the cathode active material, or may comprise the cathode active material and the ion conductive solid of the present disclosure. As the cathode active material, a known cathode active material such as a sulfide comprising a transition metal element, or an oxide including lithium and a transition metal element can be used without particular limitation. Examples thereof include LiNiVO₄, LiCoPO₄, LiCoVO₄, LiMn_{1.6}Ni_{0.4}O₄, LiMn₂O₄, LiCoO₂, Fe₂(SO₄)₃, LiFePO₄, LiNi_{1/3}Mn_{1/3}Co_{1/3}O₂, LiNi_{1/2}Mn_{1/2}O₂, LiNiO₂, Li₁₊ₓ(Fe, Mn, Co)₁₋ₓO₂, and LiNi_{0.8}Co_{0.15}Al_{0.05}O₂.

Further, the cathode may comprise a binder, an electroconductive agent, and/or the like. Examples of the binder include polyvinylidene fluoride, polytetrafluoroethylene, and polyvinyl alcohol. Examples of the electroconductive agent include natural graphite, artificial graphite, acetylene black, and ethylene black.

The all-solid-state battery of the present disclosure comprises the anode. The anode may comprise the anode active material, or may comprise the anode active material and the ion conductive solid of the present disclosure. As the anode active material, a known anode active material such as an inorganic compound such as lithium, a lithium alloy, or a tin compound, a carbonaceous material that can absorb and release a lithium ion, or a conductive polymer can be used without particular limitation. Examples thereof include Li₄Ti₅O₁₂.

Further, the anode may comprise a binder, an electroconductive agent, and/or the like. As the binder and the electroconductive agent, binders and electroconductive agents similar to those mentioned in the cathode can be used.

As used herein, electrode “comprises” electrode active material means that an electrode comprises an electrode active material as a constituent, an element, or a property. For example, a case in which an electrode active material is comprised in an electrode, and a case in which an electrode active material is applied to a surface of an electrode also correspond to the above-described “comprise”.

The cathode and the anode can be obtained by a known method such as mixture, molding, heat treatment, or the like of raw materials. It is considered that, as a result, the ion conductive solid enters gaps and the like between such electrode active materials, to facilitate security of a conduction path for lithium ions. It is considered that, since the ion conductive solid of the present disclosure can be produced by heat treatment at low temperature as compared to conventional technologies, the formation of a high-resistant phase generated by reaction between the ion conductive solid and the electrode active material can be suppressed.

The above-described cathode and the above-described anode may comprise the current collector. As the current collector, a known current collector such as aluminum, titanium, stainless steel, nickel, iron, baked carbon, a conductive polymer, or electrically conductive glass can be used. In addition, for the purpose of improving adhesiveness, electrical conductivity, oxidation resistance, and the like, aluminum, copper, or the like, of which a surface is treated with carbon, nickel, titanium, silver, or the like can be used as the current collector.

The all-solid-state battery of the present disclosure can be obtained by a known method in which, for example, the cathode, the solid electrolyte, and the anode are layered, molded, and heat-treated. It is considered that, since the ion conductive solid of the present disclosure can be produced by heat treatment at low temperature as compared to conventional technologies, the formation of a high-resistant phase generated by reaction between the ion conductive solid and the electrode active material can be suppressed, and thus that the all-solid-state battery superior in output characteristics can be obtained.

A method of measuring the composition and each physical property according to the present disclosure will now be described.

### Methods of Identifying and Analyzing Comprised Metal

The analysis of the composition of the ion conductive solid is performed by wavelength dispersion type fluorescent X-ray analysis (hereinafter also referred to as “XRF”) using a sample solidified by a pressure-molding method. However, when the analysis is difficult due to a particle size effect and/or the like, it is preferable to vitrify the ion conductive solid by a glass bead technique, and to analyze the composition thereof by XRF. When the peaks of yttrium and the peaks of the comprised metals overlap with each other in XRF, the composition analysis is preferably performed by inductively coupled plasma atomic emission spectrochemical analysis (ICP-AES).

In the case of XRF, ZSX Primus II manufactured by Rigaku Corporation is used as an analysis apparatus. The conditions of the analysis are set at use of Rh as the anode of an X-ray tube, vacuum atmosphere, an analysis diameter of 10 mm, an analysis range of 17 deg to 81 deg, a step of 0.01 deg, and a scanning speed of 5 sec/step. Moreover, the detection is performed by a proportional counter in the case of measuring a light element, while the detection is performed by a scintillation counter in the case of measuring a heavy element.

An element is identified based on the peak position of a spectrum obtained in XRF, and molar concentration ratios are calculated based on a counting rate (unit: cps) which is the number of X-ray photons per unit time, to determine a, b, c, and d.

### EXAMPLES

Examples in which the ion conductive solid of the present disclosure was specifically produced and evaluated are described below as Examples. The present disclosure is not limited to the following Examples.

### Example 1

### Primary Baking Step

Using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), and Nb₂O₅ (manufactured by MITSUI MINING & SMELTING CO., LTD., purity of 99.9%) as raw materials, each raw material was weighed in stoichiometric amounts so that d was a value set forth in Table 1, and was mixed in a planetary mill P-7 manufactured by Fritsch GmbH at a disk rotation number of 300 rpm for 30 minutes. A ball with a diameter of 5 mm, made of zirconia, and a 45 mL container were used in the planetary mill.

After the mixture, the mixed powder was cold uniaxially molded at 147 MPa using a 100 kN electric press P3052-10 manufactured by NPa SYSTEM Co., Ltd., and baked in an ambient atmosphere. The heating temperature was set at 650° C., and the retention time was set at 720 minutes.

The obtained ion conductive solid comprising the oxide was ground for 180 minutes at a disk rotation number of 230 rpm in the planetary mill P-7 manufactured by Fritsch GmbH, to produce the powder of the ion conductive solid comprising the oxide.

### Secondary Baking Step

The powder of the ion conductive solid comprising the oxide, obtained as described above, was molded and secondarily baked to produce a sintered body of the ion conductive solid comprising the oxide of Example 1. For the molding, the powder was cold uniaxially molded at 147 MPa using a 100 kN electric press P3052-10 manufactured by NPa SYSTEM Co., Ltd. The secondary baking was performed in an ambient atmosphere, the heating temperature was set at 650° C., and the retention time was set at 720 minutes.

### Example 2

The sintered body of the ion conductive solid comprising the oxide of Example 2 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), and CeO₂ (manufactured by Shin-Etsu Chemical Co., Ltd., purity of 99.9%) as raw materials, each raw material was weighed in stoichiometric amounts so that c was a value set forth in Table 1.

### Example 3

The sintered body of the ion conductive solid comprising the oxide of Example 3 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), ZrO₂ (manufactured by Nippon Denko Co., Ltd., purity of 99.9%), CeO₂ (manufactured by Shin-Etsu Chemical Co., Ltd., purity of 99.9%), and Nb₂O₅ (manufactured by MITSUI MINING & SMELTING CO., LTD., purity of 99.9%) as raw materials, each raw material was weighed in stoichiometric amounts so that c and d were values set forth in Table 1.

### Example 4

The sintered body of the ion conductive solid comprising the oxide of Example 4 was produced in the same step as that in Example 1 except that each raw material used in Examples as described above was weighed in stoichiometric amounts so that values set forth in Table 1 were achieved.

### Example 5

The sintered body of the ion conductive solid comprising the oxide of Example 5 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), and HfO₂ (manufactured by New Metals and Chemicals Corporation, Ltd., purity of 99.9%) as raw materials, each raw material was weighed in stoichiometric amounts so that c was a value set forth in Table 1.

### Example 6

The sintered body of the ion conductive solid comprising the oxide of Example 6 was produced in the same step as that in Example 1 except that each raw material used in Examples as described above was weighed in stoichiometric amounts so that c was a value set forth in Table 1.

### Example 7

The sintered body of the ion conductive solid comprising the oxide of Example 7 was produced in the same step as that in Example 1 except that each raw material used in Examples as described above was weighed in stoichiometric amounts so that c and d were values set forth in Table 1.

### Example 8

The sintered body of the ion conductive solid comprising the oxide of Example 8 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), In₂O₃ (manufactured by Shinko Chemical Co., Ltd., purity of 99% by mass), SnO₂ (manufactured by Mitsuwa Chemicals Co., Ltd., purity of 99.9%), and CeO₂ (manufactured by Shin-Etsu Chemical Co., Ltd., purity of 99.9%) as raw materials, each raw material was weighed in stoichiometric amounts so that b and c were values set forth in Table 1.

### Example 9

The sintered body of the ion conductive solid comprising the oxide of Example 9 was produced in the same step as that in Example 1 except that each raw material used in Examples as described above was weighed in stoichiometric amounts so that b and c were values set forth in Table 1.

### Example 10

The sintered body of the ion conductive solid comprising the oxide of Example 10 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Fe₂O₃ (manufactured by Wako Pure Chemical Industries, Ltd., purity of 95.0% by mass), and TiO₂ (manufactured by TOHO TITANIUM CO., LTD., purity of 99%) as raw materials, each raw material was weighed in stoichiometric amounts so that b and c were values set forth in Table 1.

### Example 11

The sintered body of the ion conductive solid comprising the oxide of Example 11 was produced in the same step as that in Example 1 except that each raw material used in Examples as described above was weighed in stoichiometric amounts so that b and c were values set forth in Table 1.

### Example 12

The sintered body of the ion conductive solid comprising the oxide of Example 12 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), and Lu₂O₃ (manufactured by Kojundo Chemical Laboratory Co., Ltd., purity of 99.9% by mass) as raw materials, each raw material was weighed in stoichiometric amounts so that b was a value set forth in Table 1.

### Example 13

The sintered body of the ion conductive solid comprising the oxide of Example 13 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), MgO (manufactured by Ube Material Industries, Ltd., purity of 99.0% by mass), and CeO₂ (manufactured by Shin-Etsu Chemical Co., Ltd., purity of 99.9%) as raw materials, each raw material was weighed in stoichiometric amounts so that a and c were values set forth in Table 1.

### Example 14

The sintered body of the ion conductive solid comprising the oxide of Example 14 was produced in the same step as that in Example 1 except that each raw material used in Examples as described above was weighed in stoichiometric amounts so that a and b were values set forth in Table 1.

### Example 15

The sintered body of the ion conductive solid comprising the oxide of Example 15 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), La₂O₃ (manufactured by Wako Pure Chemical Industries, Ltd., purity of 99.9% by mass), MgO (manufactured by Ube Material Industries, Ltd., purity of 99.0% by mass), and CaO (manufactured by KANTO CHEMICAL CO., INC., purity of 97.0% by mass) as raw materials, each raw material was weighed in stoichiometric amounts so that a and b were values set forth in Table 1.

### Example 16

The sintered body of the ion conductive solid comprising the oxide of Example 16 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), La₂O₃ (manufactured by Wako Pure Chemical Industries, Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 1.

### Example 17

The sintered body of the ion conductive solid comprising the oxide of Example 17 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Tb₂O₃ (manufactured by Shin-Etsu Chemical Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 1.

### Example 18

The sintered body of the ion conductive solid comprising the oxide of Example 18 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Tm₂O₃ (manufactured by Kojundo Chemical Laboratory Co., Ltd., purity of 99.9% by mass), and CaO (manufactured by KANTO CHEMICAL CO., INC., purity of 97.0% by mass) as raw materials, each raw material was weighed in stoichiometric amounts so that a and b were values set forth in Table 1.

### Example 19

The sintered body of the ion conductive solid comprising the oxide of Example 19 was produced in the same step as that in Example 1 except that each raw material used in Examples as described above was weighed in stoichiometric amounts so that c and d were values set forth in Table 1.

### Example 20

The sintered body of the ion conductive solid comprising the oxide of Example 20 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), In₂O₃ (manufactured by Shinko Chemical Co., Ltd., purity of 99% by mass), Nb₂O₅ (manufactured by MITSUI MINING & SMELTING CO., LTD., purity of 99.9%), and Ta₂O₅ (manufactured by KANTO CHEMICAL CO., INC., purity of 99% by mass) as raw materials, each raw material was weighed in stoichiometric amounts so that b and d were values set forth in Table 1.

### Example 21

The sintered body of the ion conductive solid comprising the oxide of Example 21 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), and Pr₂O₃ (manufactured by Shin-Etsu Chemical Co., Ltd., purity of 99.9% by mass) as raw materials, each raw material was weighed in stoichiometric amounts so that b was a value set forth in Table 1.

### Example 22

The sintered body of the ion conductive solid comprising the oxide of Example 22 was produced in the same step as that in Example 1 except that each raw material used in Examples as described above was weighed in stoichiometric amounts so that b and d were values set forth in Table 1.

### Example 23

The sintered body of the ion conductive solid comprising the oxide of Example 23 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Sm₂O₃ (manufactured by Wako Pure Chemical Industries, Ltd., purity of 99.9% by mass), HfO₂ (manufactured by New Metals and Chemicals Corporation, Ltd., purity of 99.9%), and Ta₂O₅ (manufactured by KANTO CHEMICAL CO., INC., purity of 99% by mass) as raw materials, each raw material was weighed in stoichiometric amounts so that b, c, and d were values set forth in Table 2.

### Example 24

The sintered body of the ion conductive solid comprising the oxide of Example 24 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Nd₂O₃ (manufactured by Shin-Etsu Chemical Co., Ltd., purity of 99.9% by mass), Sm₂O₃ (manufactured by Wako Pure Chemical Industries, Ltd., purity of 99.9% by mass), HfO₂ (manufactured by New Metals and Chemicals Corporation, Ltd., purity of 99.9%), and ZnO (manufactured by Wako Pure Chemical Industries, Ltd., purity of 99% by mass) as raw materials, each raw material was weighed in stoichiometric amounts so that a and b were values set forth in Table 2.

### Example 25

The sintered body of the ion conductive solid comprising the oxide of Example 25 was produced in the same step as that in Example 1 except that each raw material used in Examples as described above was weighed in stoichiometric amounts so that b and c were values set forth in Table 2.

### Example 26

The sintered body of the ion conductive solid comprising the oxide of Example 26 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), and Eu₂O₃ (manufactured by Shin-Etsu Chemical Co., Ltd., purity of 95% by mass) as raw materials, each raw material was weighed in stoichiometric amounts so that b was a value set forth in Table 2.

### Example 27

The sintered body of the ion conductive solid comprising the oxide of Example 27 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Eu₂O₃ (manufactured by Shin-Etsu Chemical Co., Ltd., purity of 95% by mass), and NiO (manufactured by Wako Pure Chemical Industries, Ltd., purity of 99.0% by mass) as raw materials, each raw material was weighed in stoichiometric amounts so that a and b were values set forth in Table 2.

### Example 28

The sintered body of the ion conductive solid comprising the oxide of Example 28 was produced in the same step as that in Example 1 except that each raw material used in Examples as described above was weighed in stoichiometric amounts so that b and c were values set forth in Table 2.

### Example 29

The sintered body of the ion conductive solid comprising the oxide of Example 29 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Gd₂O₃ (manufactured by Shin-Etsu Chemical Co., Ltd., purity of 99.9% by mass), Dy₂O₃ (manufactured by Shin-Etsu Chemical Co., Ltd., purity of 95% by mass), and CaO (manufactured by KANTO CHEMICAL CO., INC., purity of 99.0% by mass) as raw materials, each raw material was weighed in stoichiometric amounts so that a and b were values set forth in Table 2.

### Example 30

The sintered body of the ion conductive solid comprising the oxide of Example 30 was produced in the same step as that in Example 1 except that each raw material used in Examples as described above was weighed in stoichiometric amounts so that b and c were values set forth in Table 2.

### Example 31

The sintered body of the ion conductive solid comprising the oxide of Example 31 was produced in the same step as that in Example 1 except that each raw material used in Examples as described above was weighed in stoichiometric amounts so that b and c were values set forth in Table 2.

### Example 32

The sintered body of the ion conductive solid comprising the oxide of Example 32 was produced in the same step as that in Example 1 except that each raw material used in Examples as described above was weighed in stoichiometric amounts so that b was a value set forth in Table 2.

### Example 33

The sintered body of the ion conductive solid comprising the oxide of Example 33 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Tb₂O₃ (manufactured by Shin-Etsu Chemical Co., Ltd., purity of 99.9% by mass), NiO (manufactured by Wako Pure Chemical Industries, Ltd., purity of 99.0% by mass), and BaO (manufactured by Wako Pure Chemical Industries, Ltd., purity of 90.0% by mass) as raw materials, each raw material was weighed in stoichiometric amounts so that a and b were values set forth in Table 2.

### Example 34

The sintered body of the ion conductive solid comprising the oxide of Example 34 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Tb₂O₃ (manufactured by Shin-Etsu Chemical Co., Ltd., purity of 99.9% by mass), Ho₂O₃ (manufactured by Kojundo Chemical Laboratory Co., Ltd., purity of 99.9% by mass), and BaO (manufactured by Wako Pure Chemical Industries, Ltd., purity of 90.0% by mass) as raw materials, each raw material was weighed in stoichiometric amounts so that a and b were values set forth in Table 2.

### Example 35

The sintered body of the ion conductive solid comprising the oxide of Example 35 was produced in the same step as that in Example 1 except that each raw material used in Examples as described above was weighed in stoichiometric amounts so that b, c, and d were values set forth in Table 2.

### Example 36

The sintered body of the ion conductive solid comprising the oxide of Example 36 was produced in the same step as that in Example 1 except that using Li₃BO₃ (manufactured by Toshima Manufacturing Co., Ltd., purity of 99.9% by mass), H₃BO₃ (manufactured by KANTO CHEMICAL CO., INC., purity of 99.5%), Yb₂O₃ (manufactured by Shin-Etsu Chemical Co., Ltd., purity of 99.9% by mass), Er₂O₃ (manufactured by Shin-Etsu Chemical Co., Ltd., purity of 95% by mass), Tm₂O₃ (manufactured by Kojundo Chemical Laboratory Co., Ltd., purity of 99.9% by mass), and SrO (manufactured by Kojundo Chemical Laboratory Co., Ltd., purity of 98% by mass) as raw materials, each raw material was weighed in stoichiometric amounts so that a and b were values set forth in Table 2.

### Example 37

The sintered body of the ion conductive solid comprising the oxide of Example 37 was produced in the same step as that in Example 1 except that each raw material used in Examples as described above was weighed in stoichiometric amounts so that b and c were values set forth in Table 2.

### Example 38

The sintered body of the ion conductive solid comprising the oxide of Example 38 was produced in the same step as that in Example 1 except that each raw material used in Examples as described above was weighed in stoichiometric amounts so that a, b, and c were values set forth in Table 2.

### Example 39

The sintered body of the ion conductive solid comprising the oxide of Example 39 was produced in the same step as that in Example 1 except that each raw material used in Examples as described above was weighed in stoichiometric amounts so that b and d were values set forth in Table 2.

### Example 40

The sintered body of the ion conductive solid comprising the oxide of Example 40 was produced in the same step as that in Example 1 except that each raw material used in Examples as described above was weighed in stoichiometric amounts so that b, c, and d were values set forth in Table 2.

### Example 41

The sintered body of the ion conductive solid comprising the oxide of Example 41 was produced in the same step as that in Example 1 except that each raw material used in Examples as described above was weighed in stoichiometric amounts so that a, b, and c were values set forth in Table 2.

### Example 42

The sintered body of the ion conductive solid comprising the oxide of Example 42 was produced in the same step as that in Example 1 except that each raw material used in Examples as described above was weighed in stoichiometric amounts so that b and d were values set forth in Table 2.

### Example 43

The sintered body of the ion conductive solid comprising the oxide of Example 43 was produced in the same step as that in Example 1 except that each raw material used in Examples as described above was weighed in stoichiometric amounts so that b and d were values set forth in Table 2.

### Example 44

The sintered body of the ion conductive solid comprising the oxide of Example 44 was produced in the same step as that in Example 1 except that each raw material used in Examples as described above was weighed in stoichiometric amounts so that a and b were values set forth in Table 2, and a disk rotation number in pulverization was set at 300 rpm.

### Example 45

The sintered body of the ion conductive solid comprising the oxide of Example 45 was produced in the same step as that in Example 1 except that each raw material used in Examples as described above was weighed in stoichiometric amounts so that a and b were values set forth in Table 2, and a disk rotation number in pulverization was set at 300 rpm.

### Example 46

The sintered body of the ion conductive solid comprising the oxide of Example 46 was produced in the same step as that in Example 1 except that each raw material used in Examples as described above was weighed in stoichiometric amounts so that a and b were values set forth in Table 2, and a disk rotation number in pulverization was set at 300 rpm.

### Comparative Example 1

The sintered body of the ion conductive solid comprising the oxide of Comparative Example 1 was produced in the same step as that in Example 1 except that Yb₂O₃ as a raw material in Example 1 was changed to Y₂O₃, and each raw material was weighed in stoichiometric amounts so that d was a value set forth in Table 1.

### Comparative Example 2

The sintered body of the ion conductive solid comprising the oxide of Comparative Example 2 was produced in the same step as that in Example 2 except that Yb₂O₃ as a raw material in Example 2 was changed to Y₂O₃, and each raw material was weighed in stoichiometric amounts so that c was a value set forth in Table 1.

### Comparative Example 3

The sintered body of the ion conductive solid comprising the oxide of Comparative Example 3 was produced in the same step as that in Example 3 except that Yb₂O₃ as a raw material in Example 3 was changed to Y₂O₃, and each raw material was weighed in stoichiometric amounts so that c and d were values set forth in Table 1.

The sintered bodies of the ion conductive solids comprising the oxides of Examples 1 to 46 were subjected to composition analysis by the methods described above. Moreover, the volume mean particle diameters of the powders of the ion conductive solids obtained in Examples 1 to 46 and Comparative Examples 1 to 3, and the ionic conductivities of the sintered bodies of the ion conductive solids were measured by the following methods.

The methods of measuring the ionic conductivities and the volume mean particle diameters are described below. Moreover, the obtained evaluation results are set forth in Tables 1 and 2.

### Measurement of Ionic Conductivity

Two surfaces, facing each other in parallel and having a large area, of the sintered body of the ion conductive solid comprising the oxide, obtained in the secondary baking and having a flat plate shape, were polished with sandpaper. The size of the sintered body of the ion conductive solid comprising the oxide, having the flat plate shape, can be set at, for example, 0.9 cm×0.9 cm×0.05 cm, but is not limited thereto. The polishing was performed, first with #500 for 15 minutes to 30 minutes, then with #1000 for 10 minutes to 20 minutes, and finally with #2000 for 5 minutes to 10 minutes, and was completed when neither conspicuous recess/projection nor flaw was visually observed on the polished surfaces.

After the polishing, gold was deposited on the polished surfaces of the sintered body of the ion conductive solid comprising the oxide using a sputtering apparatus SC-701MkII ADVANCE manufactured by Sanyu Electron Co., Ltd. A measurement sample was made in which as deposition conditions, a process gas was Ar, a vacuum degree was set at 2 Pa to 5 Pa, and deposition time was set at 5 minutes. After the deposition, the alternating-current impedance of the measurement sample was measured.

An impedance/gain phase analyzer SI1260 and a dielectric interface system 1296 (both of which were manufactured by Solartron) were used in the measurement of the impedance, and the conditions of the measurement were set at a temperature of 27° C., an amplitude of 20 mV, and a frequency of 0.1 Hz to 1 MHz.

The resistance of the sintered body of the ion conductive solid comprising the oxide was calculated using a Nyquist plot obtained in the impedance measurement, and alternating current analysis software ZVIEW manufactured by Scribner. An equivalent circuit corresponding to the measurement sample was set by ZVIEW, and the fitting and analysis of the equivalent circuit and the Nyquist plot were performed to calculate the resistance of the sintered body of the ion conductive solid comprising the oxide. The ionic conductivity was calculated from the following equation using the calculated resistance, the thickness of the sintered body of the ion conductive solid comprising the oxide, and an electrode area.

Ionic conductivity (S/cm)=thickness (cm) of sintered body of ion conductive solid comprising oxide/(resistance (Ω) of sintered body of ion conductive solid comprising oxide× electrode area (cm²))

The ionic conductivity (S/cm) of the sintered body of the ion conductive solid is, for example, preferably 8.00×10⁻⁹ or more, more preferably 1.00×10⁻⁸ or more, still more preferably 1.00×10⁻⁷ or more, even more preferably 1.00×10⁻⁶ or more, and particularly preferably 1.00×10⁻⁵ or more. More conductivity is preferable, and the upper limit thereof is not particularly limited, and is, for example, 1.00×10⁻² or less, 1.00×10⁻³ or less, and 1.00×10⁻⁴ or less.

### Evaluation of Volume Mean Particle Diameter

The particle size distribution of the powder of the ion conductive solid comprising the oxide, obtained by ball mill treatment (planetary mill P-7 manufactured by Fritsch GmbH) after the primary baking, was measured using a laser diffraction/scattering-type particle size distribution measurement apparatus LA-960V2 manufactured by HORIBA, Ltd. A refractive index was set at 1.8, and ethanol was used as a measurement solvent. The concentration of the sample was adjusted so that a transmittance was 90 to 70%. The volume mean particle diameter was calculated from an obtained frequency distribution.

### Results

The stoichiometric amounts (values of a, b, c, and d in the general formula: Li_{6+a-c-2d} Yb_{1-a-b-c-d}M1ₐM2_{b}M3_{c}M4_{d}B₃O₉) of the raw materials, volume mean particle diameters, and ionic conductivities in the case of producing each of the sintered bodies of the ion conductive solids comprising the oxides of Examples 1 to 46 and Comparative Examples 1 to 3 are listed in Table 1.

As a result of the composition analysis described above, all the sintered bodies of the ion conductive solids comprising the oxides of Examples 1 to 46 and Comparative Examples 1 to 3 were confirmed to have the compositions in the stoichiometric amounts of the raw materials set forth in Table 1. Moreover, the sintered bodies of the ion conductive solids comprising the oxides of Examples 1 to 46 were ion conductive solids indicating the high ionic conductivities even if the baking was performed at a temperature of less than 700° C.

TABLE 1

| | | | | | | | | | Mean | Ionic |
|---|---|---|---|---|---|---|---|---|---|---|
| | Li_{6+a-c-2d}Yb_{1-a-b-c-d}M1ₐM2_{b}M3_{c}M4_{d}B₃O₉ | | | | | | | | diameter | conductivity |
| | M1 | M2 | M3 | M4 | a | b | c | d | [μm] | [S/cm] |
| Comparative | — | — | — | Nb | 0 | 0 | 0 | 0.400 | 10.1 | 5.65 × 10⁻¹⁰ |
| Example 1 | | | | | | | | | | |
| Comparative | — | — | Ce | — | 0 | 0 | 0.300 | 0 | 21.3 | 2.66 × 10⁻⁸ |
| Example 2 | | | | | | | | | | |
| Comparative | — | — | Zr:Ce = 1:1 | Nb | 0 | 0 | 0.200 | 0.100 | 15.1 | 8.73 × 10⁻⁸ |
| Example 3 | | | | | | | | | | |
| Example 1 | — | — | — | Nb | 0 | 0 | 0 | 0.400 | 11.6 | 3.11 × 10⁻⁷ |
| Example 2 | — | — | Ce | — | 0 | 0 | 0.300 | 0 | 13.5 | 4.89 × 10⁻⁷ |
| Example 3 | — | — | Zr:Ce = 1:1 | Nb | 0 | 0 | 0.200 | 0.100 | 16.9 | 5.04 × 10⁻⁷ |
| Example 4 | — | — | — | — | 0 | 0 | 0 | 0 | 15.1 | 1.10 × 10⁻⁷ |
| Example 5 | — | — | Hf | — | 0 | 0 | 0.100 | 0 | 9.6 | 5.63 × 10⁻⁶ |
| Example 6 | — | — | Zr:Ce = 4:1 | — | 0 | 0 | 0.125 | 0 | 9.3 | 5.72 × 10⁻⁵ |
| Example 7 | — | — | Zr | Nb | 0 | 0 | 0.100 | 0.025 | 0.3 | 3.07 × 10⁻⁵ |
| Example 8 | — | In | Sn | — | 0 | 0.500 | 0.400 | 0 | 8.4 | 2.56 × 10⁻⁷ |
| Example 9 | — | In | Hf | — | 0 | 0.300 | 0.100 | 0 | 8.5 | 6.68 × 10⁻⁶ |
| Example 10 | — | Fe | Ti | — | 0 | 0.100 | 0.800 | 0 | 8.5 | 1.03 × 10⁻⁸ |
| Example 11 | — | Fe | Zr:Hf = 4:1 | — | 0 | 0.400 | 0.100 | 0 | 7.9 | 4.21 × 10⁻⁶ |
| Example 12 | — | Lu | — | — | 0 | 0.900 | 0 | 0 | 9.0 | 5.47 × 10⁻⁶ |
| Example 13 | Mg | — | Ce | — | 0.025 | 0 | 0.025 | 0 | 16.3 | 1.98 × 10⁻⁶ |
| Example 14 | Mg | Lu | — | — | 0.025 | 0.800 | 0 | 0 | 8.1 | 6.44 × 10⁻⁶ |
| Example 15 | Mg:Ca = 1:1 | La | — | — | 0.100 | 0.800 | 0 | 0 | 8.0 | 8.33 × 10⁻⁸ |
| Example 16 | Mn | La | — | — | 0.800 | 0.100 | 0 | 0 | 7.7 | 6.11 × 10⁻⁸ |
| Example 17 | Mn | Tb | — | — | 0.050 | 0.100 | 0 | 0 | 20.9 | 1.53 × 10⁻⁷ |
| Example 18 | Ca | Tm | — | — | 0.050 | 0.100 | 0 | 0 | 18.3 | 1.87 × 10⁻⁷ |
| Example 19 | — | — | Sn | Nb | 0 | 0 | 0.100 | 0.400 | 11.5 | 3.77 × 10⁻⁷ |
| Example 20 | — | In | — | Nb:Ta = 1:1 | 0 | 0.300 | 0 | 0.100 | 8.6 | 5.91 × 10⁻⁶ |
| Example 21 | — | Pr | — | — | 0 | 0.500 | 0 | 0 | 10.6 | 2.74 × 10⁻⁸ |
| Example 22 | — | Pr:La = 1:1 | — | Nb | 0 | 0.100 | 0 | 0.800 | 9.7 | 7.05 × 10⁻⁹ |

TABLE 2

| | | | | | | | | | Mean | Ionic |
|---|---|---|---|---|---|---|---|---|---|---|
| | Li_{6+a-c-2d}Yb_{1-a-b-c-d}M1ₐM2_{b}M3_{c}M4_{d}B₃O₉ | | | | | | | | Diameter | Conductivity |
| | M1 | M2 | M3 | M4 | a | b | c | d | [μm] | [S/cm] |
| Example 23 | — | Sm | Hf | Ta | 0 | 0.500 | 0.050 | 0.050 | 8.1 | 4.69 × 10⁻⁷ |
| Example 24 | Zn | Nd:Sm = 1:1 | — | — | 0.100 | 0.200 | 0 | 0 | 8.3 | 3.58 × 10⁻⁷ |
| Example 25 | — | Nd | Zr | — | 0 | 0.100 | 0.100 | 0 | 12.4 | 9.14 × 10⁻⁶ |
| Example 26 | — | Eu | — | — | 0 | 0.100 | 0 | 0 | 14.2 | 1.01 × 10⁻⁷ |
| Example 27 | Ni | Eu | — | — | 0.100 | 0.100 | 0 | 0 | 23.3 | 1.96 × 10⁻⁷ |
| Example 28 | — | Eu | Zr:Hf = 4:1 | — | 0 | 0.100 | 0.100 | 0 | 11.9 | 7.59 × 10⁻⁶ |
| Example 29 | Ca | Gd:Dy = 1:1 | — | — | 0.100 | 0.200 | 0 | 0 | 9.5 | 4.31 × 10⁻⁷ |
| Example 30 | — | Gd | Zr | — | 0 | 0.100 | 0.100 | 0 | 9.1 | 1.65 × 10⁻⁵ |
| Example 31 | — | Dy | Ti:Sn = 1:1 | — | 0 | 0.100 | 0.100 | 0 | 12.6 | 6.88 × 10⁻⁶ |
| Example 32 | — | Dy | — | — | 0 | 0.100 | 0 | 0 | 8.7 | 7.13 × 10⁻⁸ |
| Example 33 | Ba:Ni = 1:1 | Tb | — | — | 0.100 | 0.100 | 0 | 0 | 26.4 | 2.81 × 10⁻⁷ |
| Example 34 | Ba | Tb:Ho = 1:1 | — | — | 0.100 | 0.200 | 0 | 0 | 14.1 | 3.88 × 10⁻⁷ |
| Example 35 | — | Tb | Hf | Ta | 0 | 0.100 | 0.050 | 0.050 | 8.2 | 6.69 × 10⁻⁷ |
| Example 36 | Sr | Er:Tm = 1:1 | — | — | 0.100 | 0.200 | 0 | 0 | 9.8 | 4.79 × 10⁻⁷ |
| Example 37 | — | Er | Ti | — | 0 | 0.100 | 0.100 | 0 | 10.8 | 1.77 × 10⁻⁷ |
| Example 38 | Ni | Er | Sn | — | 0.100 | 0.100 | 0.100 | 0 | 9.9 | 1.86 × 10⁻⁷ |
| Example 39 | — | Tm | — | Nb | 0 | 0.100 | 0 | 0.100 | 8.5 | 1.42 × 10⁻⁷ |
| Example 40 | — | Tm | Zr | Ta | 0 | 0.100 | 0.100 | 0.100 | 9.5 | 7.82 × 10⁻⁵ |
| Example 41 | Mg | Gd | Ce | — | 0.100 | 0.100 | 0.100 | 0 | 8.2 | 5.26 × 10⁻⁷ |
| Example 42 | — | Gd | — | Nb | 0 | 0.010 | 0 | 0.100 | 10.2 | 1.46 × 10⁻⁷ |
| Example 43 | — | Gd | — | Ta | 0 | 0.100 | 0 | 0.800 | 11.2 | 5.01 × 10⁻⁹ |
| Example 44 | Mn | Tb | — | — | 0.050 | 0.100 | 0 | 0 | 10.7 | 3.67 × 10⁻⁷ |
| Example 45 | Ni | Eu | — | — | 0.100 | 0.100 | 0 | 0 | 16.8 | 3.94 × 10⁻⁷ |
| Example 46 | Ba:Ni = 1:1 | Tb | — | — | 0.100 | 0.100 | 0 | 0 | 12.2 | 4.55 × 10⁻⁷ |

In Tables 1 and 2, the ionic conductivities of the ion conductive solids produced in Examples 1 to 3 were improved in comparison with those in Comparative Examples 1 to 3, indicating that higher ionic conductivity can been obtained by substitution of Y with Yb. Substitution of Y in the composition disclosed in the related art with Yb having a smaller ionic radius result in higher ionic conductivity.

Tables 1 and 2 demonstrate the result in which the ionic conductivities of the ion conductive solids produced in Examples 44 to 46 were improved in comparison with those in Examples 17, 27, and 33, respectively. Because the compositions of substituted elements are different from those disclosed in the prior art, the appropriate ranges of particle diameters may differ due to the difference in melting points and the like that affect the densities after baking.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An ion conductive solid comprising an oxide represented by a general formula: Li_{6+a-c-2d} Y_{b1-a-b-c-d}M1ₐM2_{b}M3_{c}M4_{d}B₃O₉,
where, in the formula, M1 is at least one metal element selected from a group consisting of Mg, Mn, Zn, Ni, Ca, Sr, and Ba,
M2 is at least one metal element selected from a group consisting of La, Pr, Nd, Sm, Eu, Gd, Tb, Dy, Ho, Er, Tm, Lu, In, and Fe,
M3 is at least one metal element selected from a group consisting of Zr, Ce, Hf, Sn, and Ti,
M4 is at least one metal element selected from a group consisting of Nb and Ta, and
a is 0.000≤a≤0.800, b is 0.000≤b≤0.900, c is 0.000≤c≤0.800, d is 0.000≤d≤0.800, and a, b, c, and d are real numbers satisfying 0.000≤a+b+c+d<1.000.

2. The ion conductive solid according to claim 1, wherein the 1-a-b-c-d is 0.300≤1-a-b-c-d.

3. The ion conductive solid according to claim 1, wherein the 1-a-b-c-d is 0.500≤1-a-b-c-d.

4. The ion conductive solid according to claim 1, wherein the a is 0.000≤a≤0.400.

5. The ion conductive solid according to claim 1, wherein the b is 0.000≤b≤0.500.

6. The ion conductive solid according to claim 1, wherein the c is 0.000≤c≤0.400.

7. The ion conductive solid according to claim 1, wherein the d is 0.000≤d≤0.400.

8. The ion conductive solid according to claim 1, wherein the ion conductive solid has a volume mean particle diameter of 0.1 μm or more and 28.0 μm or less.

9. An all-solid-state battery comprising at least:
a cathode;
an anode; and
an electrolyte,
wherein at least one selected from a group consisting of the cathode, the anode, and the electrolyte comprises the ion conductive solid according to claim 1.

10. The all-solid-state battery according to claim 9, wherein at least the electrolyte comprises the ion conductive solid.
